(19) United States
(12) Patent Application Publication
(10) Pub. No.: US 2014/0032595 A1
(43) Pub. Date: Jan. 30, 2014

(54) CONTENTION-FREE MULTI-PATH DATA ACCESS IN DISTRIBUTED COMPUTE SYSTEMS

(71) Applicants: Gaurav Makkar, Bangalore (IN); Arthur Lent, Newtonville, MA (US)

(72) Inventors: Gaurav Makkar, Bangalore (IN); Arthur Lent, Newtonville, MA (US)

(73) Assignee: NETAPP, INC., Sunnyvale, CA (US)

(21) Appl. No.: 13/558,061

(22) Filed: Jul. 25, 2012

(51) Int. Cl. G06F 17/30

(52) U.S. Cl. 707/770; 707/E17.044

(57) ABSTRACT

The techniques introduced herein provide for systems and methods for creating and managing a contention-free multi-path access to a distributed data set in a distributed processing system. In one embodiment, a distributed processing system comprises a plurality of compute nodes. The compute nodes are assembled into compute groups and configured such that each compute group has an attached or local storage system. Various data segments of the distributed data set are stored in data storage objects on the local storage system. The data storage objects are cross-mapped into each of the compute nodes in the compute group so that any compute node in the group can access any of the data segments stored in the local storage system via the respective data storage object.

### FIELD OF THE INVENTION

At least one embodiment of the present invention pertains to distributed data processing or analytics systems, and more particularly to contention-free (or lock-free) multi-path access to data segments of a distributed data set in a distributed processing system.

### BACKGROUND

A distributed computing or processing system comprises multiple computers (also called compute nodes or processing nodes) which operate mostly independently, to achieve or provide results toward a common goal. Unlike nodes in other processing systems such as, for example, clustered processing systems, processing nodes in distributed processing systems typically use some type of local or private memory. Distributed computing may be chosen over a centralized computing approach for many different reasons. For example, in some cases, the system or data for which the computing is being performed may be inherently geographically distributed, such that a distributed approach is the most logical solution. In other cases, using multiple processing nodes to perform subsets of a larger processing job can be a more cost effective and efficient solution. Additionally, a distributed approach may be preferred in order to avoid a system with a single point of failure or to provide redundant instances of processing capabilities.

A variety of jobs can be performed using distributed computing, one example of which is distributed data processing or analytics. In distributed data processing or analytics, the data sets processed or analyzed can be very large, and the analysis performed may span hundreds of thousands of processing nodes. Consequently, management of the data sets that are being analyzed becomes a significant and important part of the processing job. Software frameworks have been developed for performing distributed data analytics on large data sets. For example, the Google MapReduce software framework and the Apache Hadoop software framework perform distributed data analytics processes on large data sets using multiple processing nodes by dividing a larger processing job into more manageable tasks that are independently schedulable on the processing nodes. The tasks typically require one or more data segments to complete.

In the Apache Hadoop distributed processing system, a scheduler (or Hadoop Namenode) attempts to schedule the tasks with high data locality. That is, the scheduler attempts to schedule the tasks such that the data segment required to process the task is available locally at the compute node. Tasks scheduled with high data locality increase response time, avoid burdening network resources, and maximize parallel operations of the distributed processing system. A compute node has data locality if it is, for example, directly attached to a storage system on which the data segment is stored and/or if the compute node does not have to request the data segment from another compute node that is local to the data segment.

In some cases, a compute node may include one or more compute resources or slots (e.g., processors in a multi-processor server system). The compute jobs and/or tasks compete for these limited resources or slots within the compute nodes. Because there are a finite number compute resources available at any server, the scheduler often finds it difficult to schedule tasks with high data locality. Accordingly, in some cases, multiple copies of the distributed data set (i.e., replicas) are created to maximize the likelihood that the scheduler can find a compute node that is local to the data. For example, data locality can be improved by creating additional replicas or instances of the distributed data set resulting in more compute resources with data locality. However, additional instances of the distributed data set can result in data (or replica) sprawl. Data sprawl can become a problem because it increases the costs of ownership due, at least in part, to the increased storage costs. Further, data sprawl burdens the network resources that need to manage changes to the replicas across the distributed processing system.

In some cases, schedulers in distributed processing systems have been designed to increase data locality without introducing data sprawl by temporarily suspending task scheduling. However, even temporarily suspending scheduling of tasks results in additional latency which typically increases task and job response times to unacceptable levels.

Further, in current distributed computing systems, a compute node failure is not well-contained because it impacts other compute nodes in the distributed computing system. That is, the failure semantics of compute nodes impacts overall performance in distributed computing systems. For example, in Hadoop, when a compute node hosting local data (e.g., internal disks) fails, a new replica must be created from the other known good replicas in the distributed computing system. The process of generating a new replica results in a burst of traffic over the network which can adversely impact other concurrent jobs.

Unlike current distributed file systems, clustered file systems can be simultaneously mounted by various compute nodes. These clustered file systems are often referred to as shared disk file systems, although they do not necessarily have to use disk-based storage media. There are different architectural approaches to a shared disk file system. For example, some shared disk file systems distribute file information across all the servers in a cluster (fully distributed). Other shared disk file systems utilize a centralized metadata server. In any case, both approaches enable all compute nodes to access all the data on a shared storage device. However, these shared disk file systems share block level access to the same storage system, and thus must add a mechanism for concurrency control which gives a consistent and serializable view of the file system. The concurrency control avoids corruption and unintended data loss when multiple compute nodes try to access the same data at the same time. Unfortunately, the concurrency mechanisms inherently include contention between the compute nodes. This contention is typically resolved through locking schemes that increase complexity and reduce response times (e.g., processing times).

### SUMMARY

The techniques introduced herein provide for systems and methods for creating and managing multi-path access to a distributed data set in a distributed processing system. Specifically, the techniques introduced provide compute nodes with multi-path, contention-free access to data segments (or chunks) stored in data storage objects (e.g., LUNs) on a local storage system without having to build a clustered file system. Providing compute nodes in a distributed processing system with multiple contention-free paths to the same data eliminates the need to create replicas in order to achieve high data locality.

Further, unlike clustered storage systems, the techniques introduced herein provide for a contention-free (i.e., lock-free approach). Accordingly, the systems and methods include the advantages of a more loosely coupled distributed file system with the multi-path access of a clustered file system. The presented contention-free approach can be applied across compute resources and can scale to large fan-in configurations.

In one embodiment, a distributed processing system comprises a plurality of compute nodes. The compute nodes are assembled into compute groups and configured such that each compute group has an attached or local storage system. Various data segments (or chunks) of the distributed data set are stored in data storage objects (e.g., LUNs) on the local storage system. The data storage objects are cross-mapped into each of the compute nodes in the compute group so that any compute node in the group can access any of the data segments (or chunks) stored in the local storage system via the respective data storage object. In this configuration, each compute node owns (i.e., has read-write access) to one data storage object mapped into the compute node and read-only access to the remaining data storage objects mapped into the compute node. Accordingly, the data access is contention-free (i.e., lock-free) because only one compute node can modify the data segments (or chunks) stored in a specified data storage object.

Other aspects of the techniques summarized above will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements.

FIG. 1 shows an example illustrating a distributed processing environment.

FIG. 2 is a diagram illustrating an example of the hardware architecture that can implement one or more compute nodes.

FIG. 3 is a flow diagram illustrating an example process for dividing and distributing tasks in a distributed processing system.

FIG. 4 shows an example illustrating a distributed processing environment distributing a plurality of tasks to compute resources of compute nodes in a distributed processing system.

FIG. 5 shows an example illustrating access rights of a compute group in a distributed processing system.

FIGS. 6A and 6B show an example illustrating operation of the compute nodes in a compute group of a distributed processing system.

FIGS. 7A and 7B show examples of the contents of cached file system meta-data in a distributed processing system.

FIGS. 8A and 8B show a flow diagram illustrating an example process for processing and performing a task at a compute node of a distributed processing system.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

In some embodiments, the following detailed description is described with reference to systems and methods for creating and maintaining a Hadoop distributed processing system that provides multi-path contention-free access to a distributed a data set. However, the systems and methods described herein are equally applicable to any distributed processing system.

In one embodiment, a distributed processing system comprises a plurality of compute nodes. The compute nodes are assembled into compute groups and configured such that each compute group has an attached or local storage system. Various data segments (or chunks) of the distributed data set are stored in data storage objects (e.g., LUNs) on the local storage system. The data storage objects are cross-mapped into each of the compute nodes in the compute group so that any compute node in the group can access any of the data segments (or chunks) stored in the local storage system via the respective data storage object. In this configuration, each compute node owns (i.e., has read-write access) to one data storage object mapped into the compute node and read-only access to the remaining data storage objects mapped into the compute node. Accordingly, the data access in the resulting distributed processing system is contention-free (i.e., lock-free) because only one compute node can modify the data segments (or chunks) stored in a specified data storage object.

In this configuration, multiple paths are created to the various data segments (or chunks) of the distributed data set stored in data storage objects (e.g., LUNs) on the local storage system. For example, a compute group having three compute nodes would have three paths to the various data segments (or chunks). In this configuration, one of the paths is read-write and the remaining paths are read-only, and thus, the compute nodes can access the various data segments (or chunks) via multiple paths without using a clustered file system because the access is contention-free. Further, because many tasks merely require access to a data segment (or chunk), but do not need to modify (i.e., write) the data segment, a job distribution system (e.g., scheduler) can schedule tasks that require only read access on any of the plurality of compute nodes in the compute group. Thus, from the scheduler's perspective creating multiple paths to the same data segments is essentially the same as creating multiple replicas of the data segments (or chunks), without actually having to create and maintain those replicas.

In this configuration, the compute nodes with read-only access to a data storage object are kept apprised of any changes made to that data storage object (i.e., changes made by the compute node that has read-write access) through the use of one or more transaction logs (e.g., write ahead logs). In one embodiment, a transaction log is kept in the storage system for each data storage object (e.g., LUN). In this example, the transaction log includes indications such as, for example, references to the data that changed in the data storage object. For example, the data storage object can be represented by a file system that is divided into meta-data and data portions. The transaction log can point the compute nodes with read-only access to the data storage object to the changes in meta-data and/or data in the data storage object so that those compute nodes do not have to re-ingest the entire data set stored on the data storage object.

In one embodiment, the distributed processing system is a totally-ordered Write-Once Read Many (WORM) system. In totally-ordered systems, the order in which allocations and deallocations (e.g., additions and/or deletions of data) occur are preserved. Accordingly, in some embodiments discussed herein, references to “modifying” data segments and/or data can refer to making additions or deletions of data in data storage objects.

In one embodiment, the contention-free multi-path configuration results in fewer or no replicas. The contention-free multi-path configuration accomplishes this by using “multiple virtual replicas.” That is, a single data storage object can present itself to a plurality of compute nodes in a distributed processing system as a virtual replica of the data storage object. The various compute nodes believe that they have local access to a copy of the single physical data storage object (e.g., LUN). The reduction in actual replicas through the use of “multiple virtual replicas” resolves potential data sprawl issues while increasing data locality and job response latency. The decrease in replicas also reduces network burden, system complexity, job response latency, and total cost of ownership due to the smaller system footprint.

In one embodiment, the contention-free multi-path configuration also results in increased I/O bandwidth and increased utilization of the network resources, improving ingest performance. The contention-free multi-path configuration also minimizes intra-switch and inter-rack communication as most jobs are scheduled with high data locality eliminating the need to for compute nodes to request data over the network resources.

In one embodiment, the contention-free multi-path configuration also results in increased high-availability (HA) semantics and limited or no use of network bandwidth for replication on failure of compute clusters. The contention-free multi-path configuration increases HA semantics and limits use of network bandwidth for replication on failure of a compute clusters. That is, if one path is down, then the data is still available via another path. The HA semantics also provide flexibility to the scheduler. That is, if one compute cluster goes down, then the scheduler still has access to (via the other paths) the data segments (or chunks) stored in the specified data storage object through other compute nodes. Additionally, the HA semantics reduce system downtime and/or accessibility in near real-time analytics as down-time in real-time or near real-time analytics is prohibitive due to the nature of the business impact.

In one embodiment, the contention-free multi-path configuration results in the ability of a job distribution system (or scheduler) to engineer creation of hot-spots in distributed file system operation. The storage system can then leverage small amounts of flash at a storage controller to improve performance over traditional distributed or Hadoop clusters.

In one embodiment, the contention-free multi-path configuration results in a distributed processing system that can scale linearly because the system is “communication-free.” Accordingly, new compute nodes and/or data storage objects can be added and/or deleted from the distributed processing system without communicating the change to the other compute nodes.

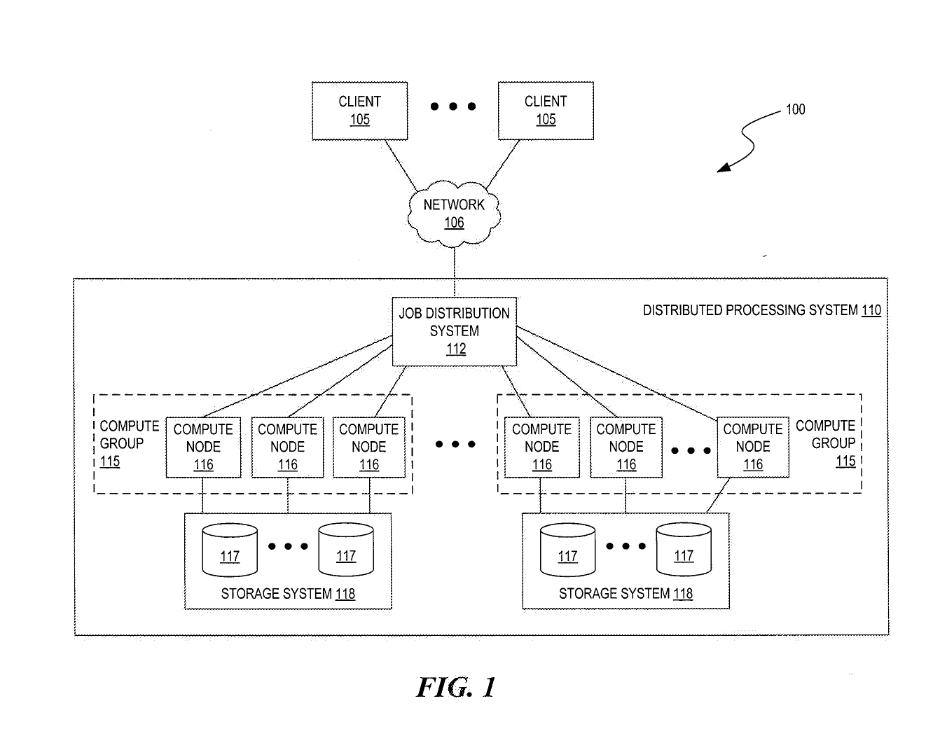

Referring now to FIG. 1, which illustrates an example of a distributed processing environment 100. Distributed processing environment 100 includes a plurality of client systems 105, a distributed processing system 110, and a network 106 connecting the client systems 105 and the distributed processing system 110. As shown in FIG. 1, the distributed processing system 110 includes two compute groups 115 and a job distribution system 112. Each compute group 115 includes a plurality of compute nodes 116 that are coupled with the job distribution system 112 and a storage system 118. Two compute groups 115 are shown for simplicity of discussion. The distributed processing system 110 can include any number of compute groups 115 each including any number of compute node 116. The storage system 118 can include a storage controller (not shown) and a number of mass storage devices (or storage containers) 117, such as disks. Alternatively, some or all of the mass storage devices 117 can be other types of storage, such as flash memory, solid-state drives (SSDs), tape storage, etc. However, for ease of description, the storage devices 117 are assumed to be disks herein and the storage system 118 is assumed to be a disk array.

The job distribution system 112 coordinates functions relating to the processing of jobs. This coordination function may include one or more of: receiving a job from a client 105, dividing each job into tasks, assigning or scheduling the tasks to one or more compute nodes 116, monitoring progress of the tasks, receiving the divided tasks results, combining the divided tasks results into a job result, and reporting the job result to the client 105. In one embodiment, the job distribution system 112 can include, for example, one or more HDFS Namenode servers. The job distribution system 112 can be implemented in special-purpose hardware, programmable hardware, or a combination thereof. As shown, the job distribution system 112 is illustrated as a standalone element. However, the job distribution system 112 can be implemented in a separate computing device. Further, in one or more embodiments, the job distribution system 112 may alternatively or additionally be implemented in a device which performs other functions, including within one or more compute nodes.

The job distribution system 112 performs the assignment and scheduling of tasks to compute nodes 116 with some knowledge of where the required data segments of distributed data set reside. That is, the job distribution system 112 has knowledge of the compute groups 115 and the data stored on the associated storage system(s) 118. The job distribution system 112 attempts to assign or schedule tasks at compute nodes 116 with data locality, at least in part, to improve performance. In some embodiments, the job distribution system 112 includes some or all of the metadata information associated with the distributed file system in order to map the tasks to the appropriate compute nodes 116. Further, in some embodiments, the job distribution system 112 can determine whether the task requires write access to one or more data segments and, if so, can assign or schedule the task with a compute node 116 that has read-write access to the data segment. The job distribution system 112 can be implemented in special-purpose hardware, programmable hardware, or a combination thereof.

Compute nodes 116 may be any type of microprocessor, computer, server, central processing unit (CPU), programmable logic device, gate array, or other circuitry which performs a designated processing function (i.e., processes the tasks and accesses the specified data segments). In one embodiment, compute nodes 116 can include a cache or memory system that caches distributed file system meta-data for one or more data storage objects such as, for example, logical unit numbers (LUNs) in a storage system. The compute nodes 116 can also include one or more interfaces for communicating with networks, other compute nodes, and/or other devices. In some embodiments, compute nodes 116 may also include other elements and can implement these various elements in a distributed fashion.

The storage system 118 can include a storage server or controller (not shown) and one or more disks 117. In one embodiment, the disks 117 may be configured in a disk array. For example, the storage system 118 can be one of the E-series storage system products available from NetApp®, Inc. The E-series storage system products include an embedded controller (or storage server) and disks. The E-series storage system provides for point-to-point connectivity between the compute nodes 116 and the storage system 118. In one embodiment, the connection between the compute nodes 116 and the storage system 118 is a serial attached SCSI (SAS). However, the compute nodes 116 may be connected by other means known in the art such as, for example over any switched private network.

In another embodiment, one or more of the storage systems can alternatively or additionally include a FAS-series or E-series of storage server products available from NetApp®, Inc. In this example, the storage server (not shown) can be, for example, one of the FAS-series or E-series of storage server products available from NetApp®, Inc. In this configuration, the compute nodes 116 are connected to the storage server via a network (not shown), which can be a packet-switched network, for example, a local area network (LAN) or wide area network (WAN). Further, the storage server can be connected to the disks 117 via a switching fabric (not shown), which can be a fiber distributed data interface (FDDI) network, for example. It is noted that, within the network data storage environment, any other suitable number of storage servers and/or mass storage devices, and/or any other suitable network technologies, may be employed.

The one or more storage servers within storage system 118 can make some or all of the storage space on the disk(s) 117 available to the compute nodes 116 in the attached or associated compute group 115. For example, each of the disks 117 can be implemented as an individual disk, multiple disks (e.g., a RAID group) or any other suitable mass storage device(s). Storage of information in the storage system 118 can be implemented as one or more storage volumes that comprise a collection of physical storage disks 117 cooperating to define an overall logical arrangement of volume block number (VBN) space on the volume(s). Each logical volume is generally, although not necessarily, associated with its own file system.

The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used according to the techniques described herein. One or more RAID groups together form an aggregate. An aggregate can contain one or more volumes.

The storage system 118 can receive and respond to various read and write requests from the compute nodes 116, directed to data segments stored in or to be stored in the storage system 118. In one embodiment, the storage system 118 also includes an internal buffer cache (not shown), which can be implemented as DRAM, for example, or as non-volatile solid-state memory, such as flash memory. In one embodiment, the buffer cache comprises a host-side flash cache that accelerates I/O to the compute nodes 116. Although not shown, in one embodiment, the buffer cache can alternatively or additionally be included within one or more of the compute nodes 116. In some embodiments, the job distribution system 112 is aware of the host-side cache and can artificially create hotspots in the distributed processing system.

In one embodiment, a storage server (not shown) within a storage system 118 can be configured to implement one or more virtual storage servers. Virtual storage servers allow the sharing of the underlying physical storage controller resources, (e.g., processors and memory, between virtual storage servers while allowing each virtual storage server to run its own operating system) thereby providing functional isolation. With this configuration, multiple server operating systems that previously ran on individual machines, (e.g., to avoid interference) are able to run on the same physical machine because of the functional isolation provided by a virtual storage server implementation. This can be a more cost effective way of providing storage server solutions to multiple customers than providing separate physical server resources for each customer.

In one embodiment, various data segments (or chunks) of the distributed data set are stored in data storage objects (e.g., LUNs) on storage systems 118. Together the storage systems 118 comprise the entire distributed data set. The data storage objects in a storage system 118 are cross-mapped into each compute node 116 of an associated compute group 115 so that any compute node 116 in the compute group 115 can access any of the data segments (or chunks) stored in the local storage system via the respective data storage object. Each compute node 116 owns (i.e., has read-write access) to one data storage object mapped into the compute node 116 and read-only access to the remaining data storage objects mapped into the compute node 116. Accordingly, data access from the plurality of compute nodes 116 in the compute group 115 is contention-free (i.e., lock-free) because only one compute node 116 can modify the data segments (or chunks) stored in a specified data storage object within storage system 118.

In this configuration, multiple paths are created to the various data segments (or chunks) of the distributed data set stored in data storage objects (e.g., LUNs) on the local storage system. For example, a compute group 115 having three compute nodes 116 has three paths to the various data segments (or chunks). However, only one of these paths is read-write, and thus, the compute nodes 116 can access the various data segments (or chunks) contention-free via multiple paths. In this configuration, the job distribution system 112 can more easily schedule tasks with data locality because many tasks merely require access to a data segment (or chunk), but do not need to modify (i.e., write) the data segment, thus, the job distribution system 112 can schedule tasks that require only read access on any of the plurality of compute nodes 116 in the compute group 115 with read-only access to the data storage object on the storage system 118.

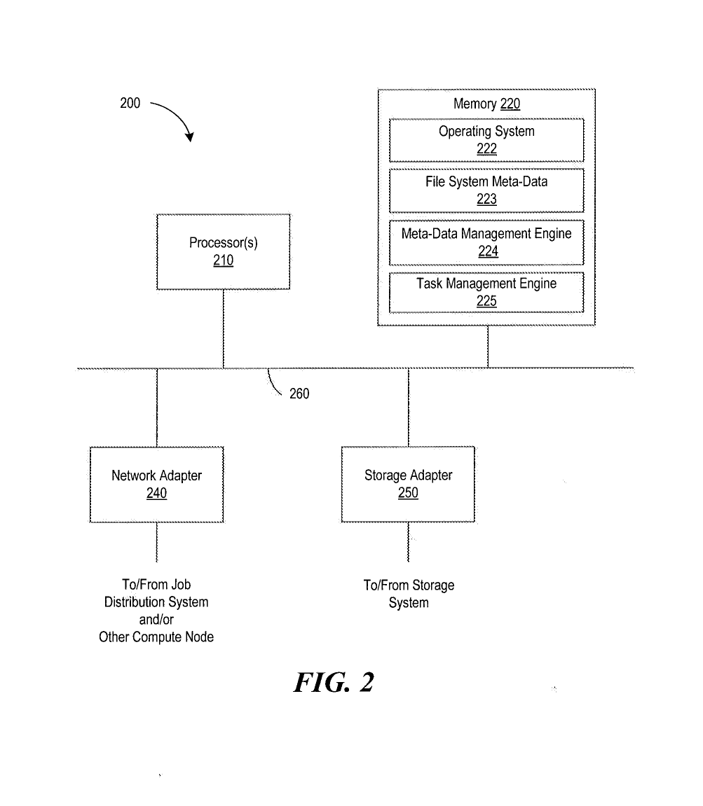

FIG. 2 is a diagram illustrating an example of the hardware architecture of a compute node 200 that can implement one or more compute nodes, for example, compute nodes 116 of FIG. 1. The compute node 200 may be any type of microprocessor, computer, server, central processing unit (CPU), programmable logic device, gate array, or other circuitry which performs a designated processing function (i.e., processes the tasks and accesses the specified data segments). In an illustrative embodiment, the compute node 200 includes a processor subsystem 210 that includes one or more processors. The compute node 200 further includes a memory 220, a network adapter 240, and a storage adapter 250, all interconnected by an interconnect 260.

The compute node 200 can be embodied as a single- or multi-processor storage server executing an operating system 222. The operating system 222, portions of which are typically resident in memory and executed by the processing elements, controls and manages processing of the tasks. The memory 220 illustratively comprises storage locations that are addressable by the processor(s) 210 and adapters 240 and 250 for storing software program code and data associated with the techniques introduced here. For example, some of the storage locations of memory 220 can be used for cached file system meta-data 223, a meta-data management engine 224, and a task management engine 225. The cached file system meta-data 223 can include meta-data associated with each data storage object that is mapped into the compute node 200. This file system meta-data is typically, although not necessarily, ingested at startup and is updated periodically and/or based on other triggers generated by the meta-data management engine 224.

The task management engine can include the software necessary to process a received request to perform a task, identify the particular data segments required to complete the task, and process the data segments to identify the particular data storage object on which the data segment resides. The task management engine can also generate a request for the data segment. The processor 210 and adapters may, in turn, comprise processing elements and/or logic circuitry configured to execute the software code. It will be apparent to those skilled in the art that other processing and memory implementations, including various computer readable storage media, may be used for storing and executing program instructions pertaining to the techniques introduced here. Like the compute node itself, the operating system 222 can be distributed, with modules of the storage system running on separate physical resources.

The network adapter 240 includes a plurality of ports to couple compute nodes 116 with the job distribution system 112 and/or with other compute nodes 116 both in the same compute group 115 and in different compute groups 115. The ports may couple the devices over point-to-point links, wide area networks, virtual private networks implemented over a public network (Internet) or a shared local area network. The network adapter 240 thus can include the mechanical components as well as the electrical and signaling circuitry needed to connect the compute node 200 to the network 106 of FIG. 1 and/or other local or wide area networks. Illustratively, the network 106 can be embodied as an Ethernet network or a Fibre Channel network. In one embodiment, clients 105 can communicate with the job distribution system 112 and the job distribution system 112 can communicate with compute nodes 116 over the network 106 by exchanging packets or frames of data according to pre-defined protocols, such as Transmission Control Protocol/Internet Protocol (TCP/IP).

The storage adapter 250 cooperates with the operating system 222 to access information requested by the compute nodes 116. The information may be stored on any type of attached array of writable storage media, such as magnetic disk or tape, optical disk (e.g., CD-ROM or DVD), flash memory, solid-state drive (SSD), electronic random access memory (RAM), micro-electro mechanical and/or any other similar media adapted to store information, including data and parity information. However, as illustratively described herein, the information is stored on disks 117. The storage adapter 250 includes a plurality of ports having input/output (I/O) interface circuitry that couples with the disks over an I/O interconnect arrangement, such as a conventional high-performance, Fibre Channel link topology. In one embodiment, the storage adapter 250 includes, for example, an E-series adapter to communicate with a NetApp E-Series storage system 118.

The operating system 222 facilitates compute node 116 access to data segments stored in data storage objects on the disks 117. As discussed above, in certain embodiments, a number of data storage objects or LUNs are mapped into each compute node 116. The operating system 222 facilitates the compute nodes 116 processing of the tasks and access to the required data segments stored in the data storage objects on the disks 117.

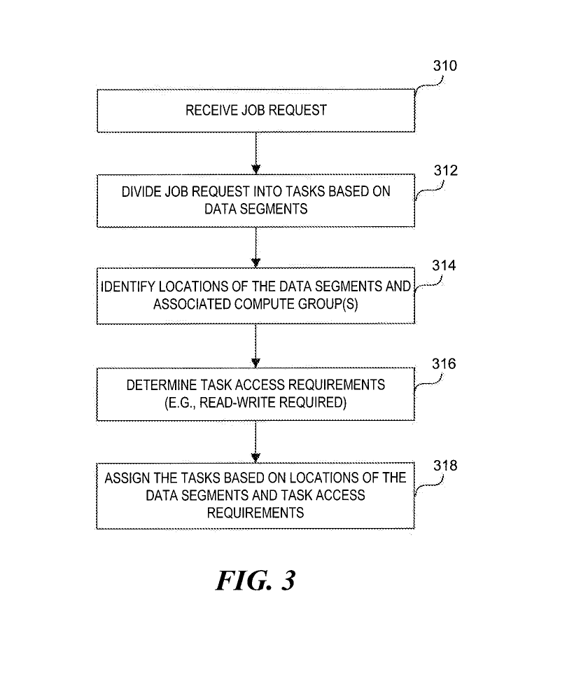

FIG. 3 is a flow diagram illustrating an example process 300 for dividing a job into a plurality of tasks and distributing those tasks to a plurality of compute nodes such as, for example, the compute nodes 116 of FIG. 1. The job distribution system such as, for example, the job distribution system 112 of FIG. 1, among other functions, divides jobs into tasks and distributes the tasks to compute nodes.

In the receiving stage, at step 310, the job distribution system receives a job request from a client such as, for example, clients 105 of FIG. 1. The job request may be received over a network such as, for example network 106 of FIG. 1. In the job dividing stage, at step 312, the job distribution system divides the job into a plurality of tasks based on the data segments required to complete the task. For example, the task may need to access (e.g., read or write) a specific data segment (e.g., file or block) in order to complete the task. Accordingly, the job distribution system breaks up or divides the received job into one or more tasks that require smaller chunks of data or data segments. Ideally, these tasks can be completed concurrently once assigned to compute nodes in the distributed processing system.

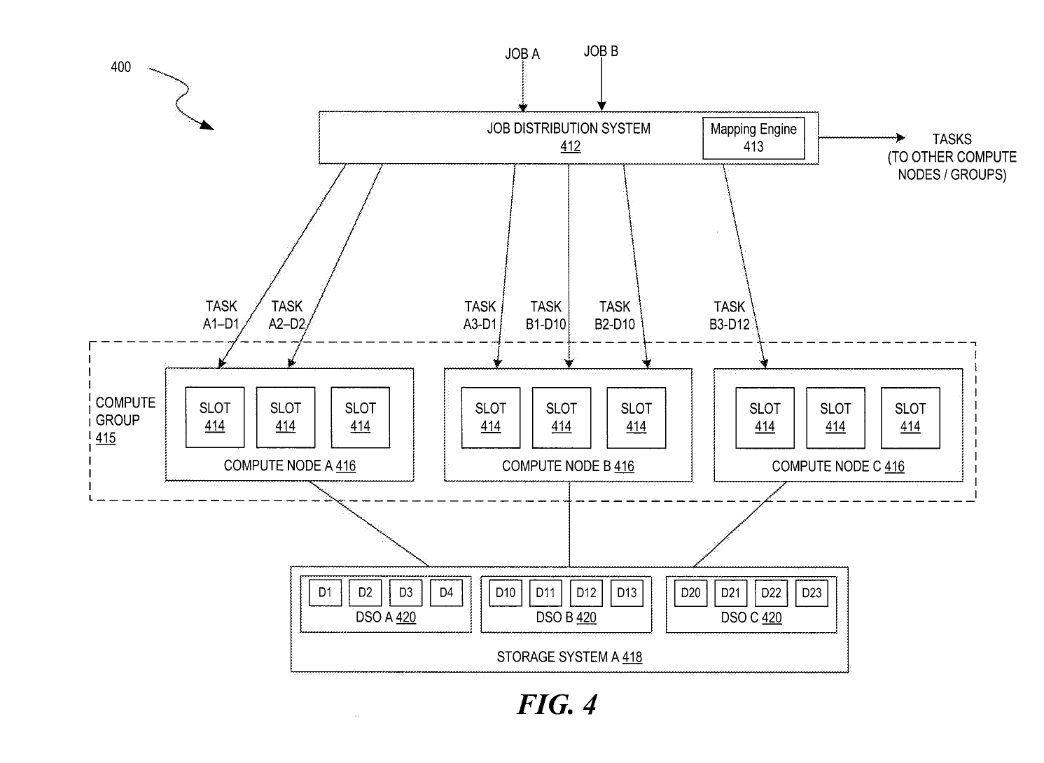

In the identification stage, at step 314, the job distribution system identifies locations of the data segments. That is, the job distribution system determines on which storage system(s) the data segments reside. In one embodiment, the job distribution system also identifies the associated compute group and one or more compute nodes in the compute group that have access to the data segments. Accordingly, the job distribution system identifies a number of paths to the data segments that are required to perform the tasks. Although not shown, in one or more embodiments, each compute node includes multiple resources or slots and thus, can concurrently process more than one task. The job distribution system is aware of each of each of these compute resources or slots. An example illustrating the use of slots is discussed in more detail with respect to FIG. 4.

In the access stage, at step 316, the job distribution system determines whether each of the tasks require read-write access to the respective data segments. If read-write access is required, then the job distribution system must assign the task to a specific compute node in the compute group (i.e., the compute node that owns the data storage object on which the required data segment resides). Otherwise, if read-only access is required, then the job distribution system can assign the task to any of the plurality of compute nodes in the compute group. Lastly, in the assign stage, at step 318, the job distribution system assigns the tasks based on the locations of the data segments (i.e., data locality) and the task access requirements (i.e., whether the tasks require read-write or read-only access).

FIG. 4 shows an example diagram illustrating division and distribution of tasks to slots 414 (or compute resources) within compute nodes 416 in a distributed processing system 400. The job distribution system 412 and the compute nodes 416 may be the job distribution system 112 and compute nodes 116 of FIG. 1, respectively, although alternative configurations are possible.

In one embodiment, the job distribution system 412 coordinates functions relating to the processing of jobs. This coordination function may include one or more of: receiving a job from a client, dividing each job into tasks, assigning or scheduling the tasks to one or more compute nodes 416, monitoring progress of the tasks, receiving the divided tasks results, combining the divided tasks results into a job result, and reporting the job result to the client. In one embodiment, the job distribution system 412 can include, for example, one or more HDFS Namenode servers. The job distribution system 412 can be implemented in special-purpose hardware, programmable hardware, or a combination thereof. As shown, the job distribution system 412 is illustrated as a standalone element. However, the job distribution system 412 can be implemented in a separate computing device. Further, in one or more embodiments, the job distribution system 412 may alternatively or additionally be implemented in a device which performs other functions, including within one or more compute nodes.

The job distribution system 412 performs the assignments and scheduling of tasks to compute nodes 416. In one embodiment, the compute nodes 416 include one or more slots or compute resources 414 that are configured to perform the assigned tasks. Each slot may comprise a processor, for example, in a multiprocessor system. Accordingly, in this embodiment each compute node 416 may concurrently process a task for each slot or compute resource 414. In one embodiment, the job distribution system 412 is aware of how many slots or compute resources 414 that are included in each compute node and assigns tasks accordingly. Further, in one embodiment, the number of slots 414 included in any given compute node 416 can be expandable. The job distribution system 412 attempts to assign or schedule tasks at compute nodes 416 with data locality, at least in part, to improve task performance and overall distributed processing system performance. In one embodiment, the job distribution system 412 includes a mapping engine 413 that can include some or all of the metadata information associated with the distributed file system in order to map (or assign) the tasks to the appropriate compute nodes 116. Further, the mapping engine 413 can also include information that distinguishes read-write slots 414 and nodes 416 from read-only slots 414 and nodes 416.

In one example of operation, the job distribution system 112 receives a job from a client such as client 105 of FIG. 1, and subsequently divides the job into a plurality of tasks based on the data segments required to perform the tasks. As shown in this example, Job A and Job B are received at the job distribution system 412 and the job distribution system 412 subsequently divides each job into three tasks (i.e., tasks A1-A3 and tasks B1-B3). Each job is divided into three tasks for simplicity of description; however, it is appreciated that each job can be divided into any number of tasks including a single task in some instances.

In one embodiment, each job is divided into tasks based, at least in part, on one or more data segments that are required to complete the tasks. Each data segment is stored on a storage system 418 that is local to or directly attached to a compute group 415. The mapping engine 413 includes meta-data information that indicates which compute group 415 is local to which data segment. The mapping engine 413 uses this information to attempt to map the tasks to compute nodes 416 that are local to the data. Further, in one embodiment, the mapping engine 413 also has knowledge of which compute nodes from the compute group 415 have read-write access and which compute nodes have read-only access.

In the example of FIG. 4, the storage system A 418 includes a plurality of data segments stored on a plurality of logical data storage objects (DSO) 420. The data storage objects can be, for example, LUNs. In this example, each of the data storage objects is cross-mapped into each of the compute nodes 416 (i.e., compute nodes A, B, and C) and each compute node 416 owns (i.e., has read-write access to) one of the data storage objects. In this case, compute node A owns DSO A, compute node B owns DSO B, and compute node B owns DSO C. Further, the data storage objects each have a plurality of data segments stored thereon. In this case, DSO A has data segments D1, D2, D3, and D4 stored thereon; DSO B has data segments D11, D12, D13, D14, and D15 stored thereon; and, DSO C has data segments D20, D21, D22, D23 stored thereon.

In the example of FIG. 4, the job distribution system 412 assigns Tasks A1 and A2 to compute node A 416 because the tasks require read-write access to data segments D1 and D2, respectively. Task A3 is assigned to compute node B because the task requires read-only access to data segment D1. Tasks B1 and B2 are assigned to compute node B because they require read-write access to data segment D10. In this case, task B3 requires read-only access to data segment D12 and thus could be assigned to any compute node in the compute group 415. The job distribution system 412 assigns the task to compute node C in this case to keep a slot open at compute node A for read-write access to DSO A. In addition to the assignments and mappings shown, it is appreciated that the job distribution system 412 may also assign tasks from Job A and/or Job B (or other Jobs that are not shown) to other compute nodes and groups.

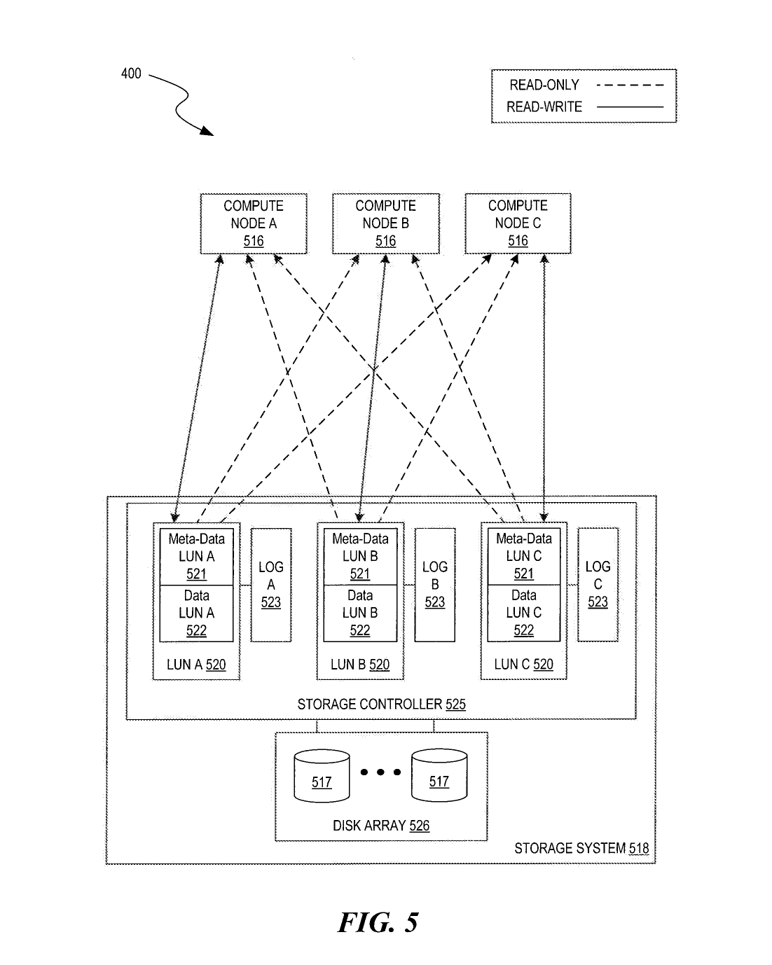

FIG. 5 shows an example diagram 500 illustrating the logical storage access rights (i.e., read-only and read-write access rights) associated with the compute nodes 516 in a distributed processing system 500. More specifically, FIG. 5 illustrates the access rights of compute nodes to various owned and not-owned data storage objects (i.e., LUNs 520). The compute nodes 516 and storage system 518 may be the compute nodes 116 and storage system 518 of FIG. 1, respectively, although alternative configurations are possible.

In one embodiment the storage system 518 includes a storage controller 525 and a disk array 526 including a plurality of disks 517. In FIG. 5, a single storage system 518 is shown. In some embodiments, any number of storage systems can be utilized. For example, in some embodiments, a storage system can be associated with (e.g., “owned” by) each compute node. The storage system 518 can be one of the E-series storage system products available from NetApp®, Inc. The E-series storage system products include an embedded controller (or storage server) and disks. The E-series provides for point-to-point connectivity between the compute nodes 116 and the storage system 118. In one embodiment, the connection between the compute nodes 116 and the storage system 118 is a serial attached SCSI (SAS). However, the compute nodes 116 may be connected by other means known in the art such as, for example over any switched private network.

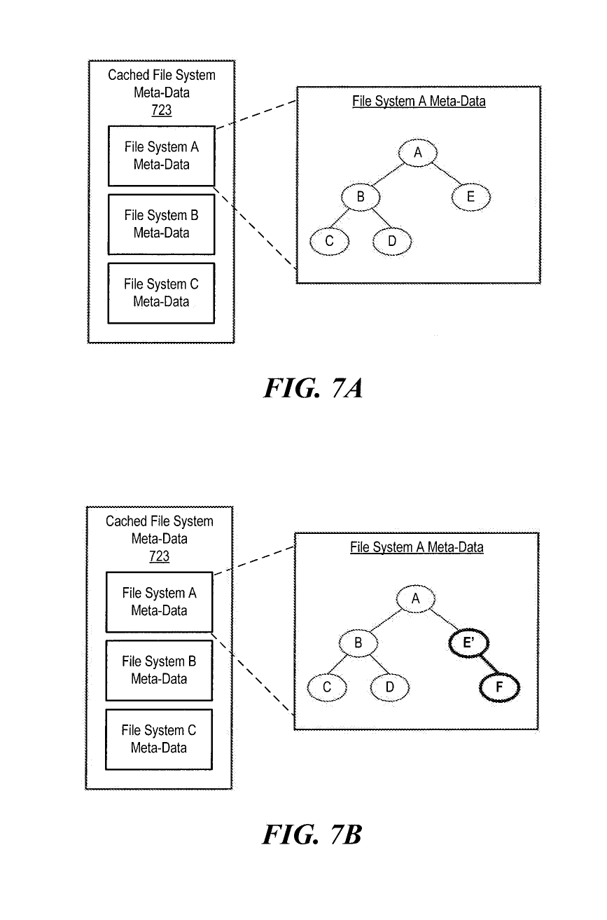

In this example, the data available on the disk array 526 is logically divided by the storage system 518 into a plurality of data storage objects or LUNs 520 (i.e., LUN A, LUN B, and LUN C). Each LUN includes a meta-data portion 521 and a data portion 522 which may be separately stored on the storage system 518. Each LUN is also associated with a log 523 (i.e., LOG A, LOG B, LOG C). The log may be, for example, a write ahead log that includes incremental modifications to the LUN 520 (i.e., writes to the LUN by the owners of the LUN). An example of the log contents are discussed in more detail with respect to FIG. 7.

In one embodiment, each compute node 516 owns a LUN 520 and an associated LOG 523. The compute node that owns the LUN 520 is the only compute node in a compute group (or in the distributed processing system for that matter) that can write to or modify the data stored on that LUN. In this example, compute node A owns LUN A and LOG A, compute node B owns LUN B and LOG B, and compute node C owns LUN C and LOG C.

In one embodiment, the compute nodes 516 ingest (or cache) the meta-data 521 associated with each of the LUNS 520 at startup. Typically, the file system meta-data is ingested bottom-up. That is, the data from the logical bottom of a file system tree is ingested upward until a superblock or root is read. The compute nodes 516 may store this file system data in a memory for example, memory 220 of FIG. 2. The owners of the LUNs 520 can then make changes to the data that is stored on the LUN including the associated meta-data. For example, compute node A may receive a task requiring it to write a data segment on LUN 520. When compute node A writes the data segment, modifications can occur in both the LUN A meta-data 521 and the LUN A data 522. Unfortunately, compute nodes B and C are unaware of these changes unless they re-ingest the LUN A meta-data 521. However, re-ingesting the file system meta-data is time consuming and would reduce system performance. Thus, compute nodes write incremental modifications to the log 523 that they own in addition to writing the modified data and meta-data to the data storage object (e.g., LUN).

The compute nodes 516 that do not own the LUN 520 can then read the log 523 in order to identify any changes to the LUN meta-data 521. For example, non-owner compute nodes of LUN A 520 (compute nodes B and C) can periodically read the log A to identify any incremental changes to log A made by compute node A. In one embodiment, non-owner compute nodes may periodically read the log, for example, every two to fifteen seconds.

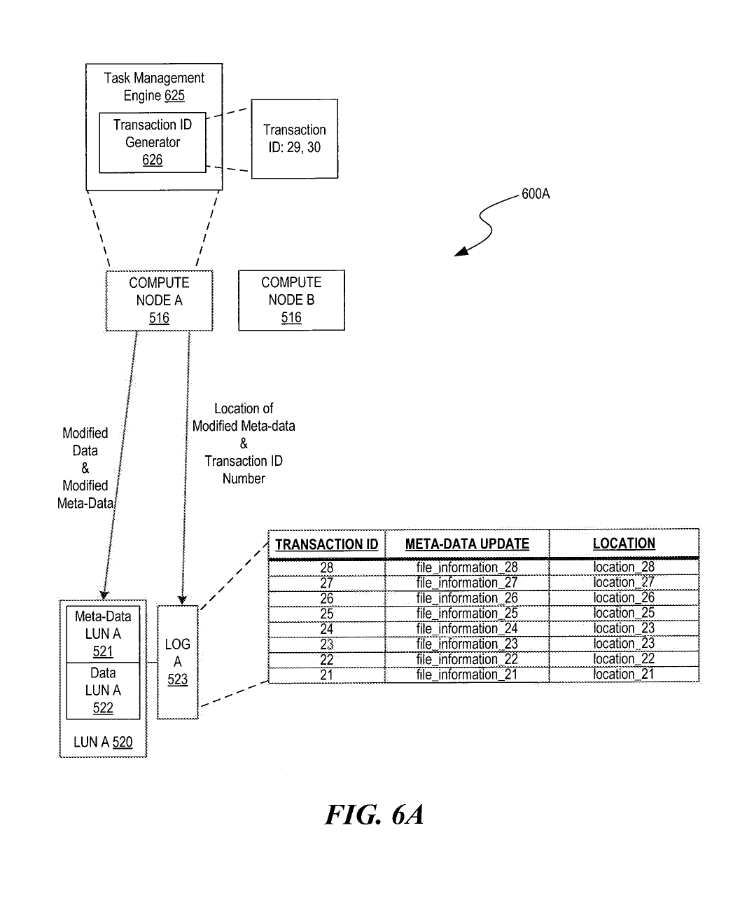

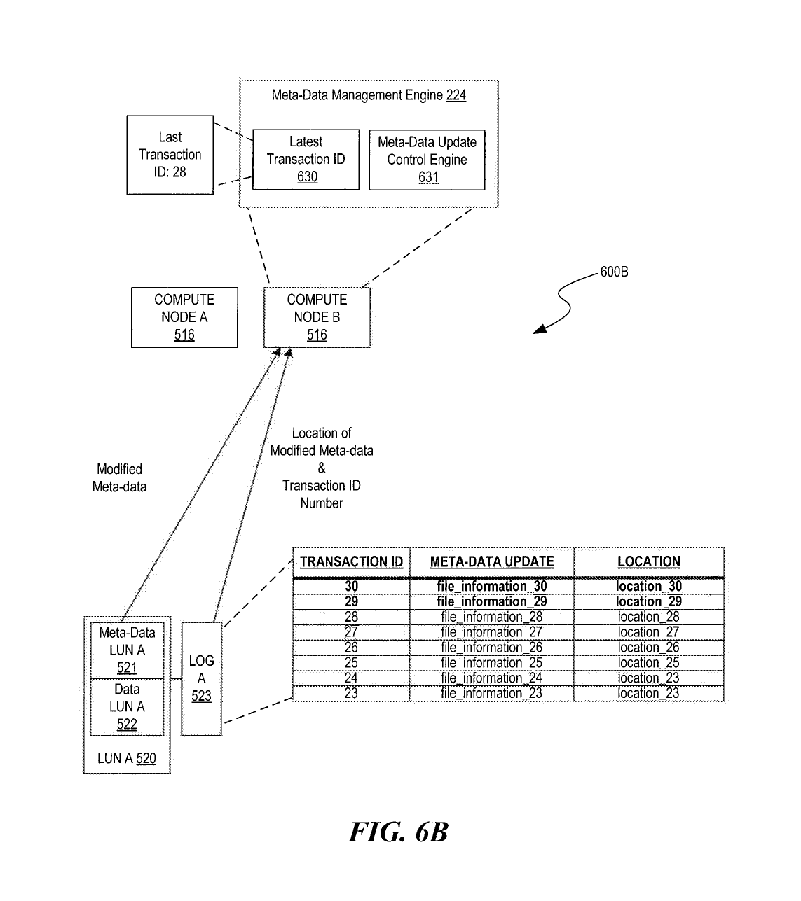

FIGS. 6A and 6B show an example of the compute node A of FIG. 5 modifying or writing LUN A and LOG A and compute node B of FIG. 5 subsequently reading LOG A to identify the incremental modifications to the LUN A meta-data 521.

Referring first to FIG. 6A, which shows example 600A illustrating compute node A modifying data and meta-data in LUN A meta-data 521 and LUN A data 522, respectively. As discussed, compute node A can make these modifications responsive to tasks performed at compute node A. As shown, compute node A includes a task management engine 625 such as, for example, the task management engine 225 of FIG. 2. The task management engine 625 includes a transaction identification (ID) generator 626 that generates a transaction ID for each modification made by compute node A. In one embodiment, responsive to an indication that a task needs to write or modify LUN A, the transaction ID generator generates an ID to be associated with the location of the modified meta-data. The transaction ID is associated the location of the meta-data and (in some cases) the meta-data itself. This information is written to LOG A. As shown in FIG. 6A, LOG A has not yet applied the updated transactions 29 and 30.

FIG. 6B shows example 600B illustrating compute node B reading LOG A to obtain the transaction modifications subsequent to compute node A writing the modifications in example 600A. Compute node B includes a meta-data management engine 624. The meta-data management engine includes a latest transaction ID 630 and a meta-data update control engine 631. In this example, the latest transaction ID is 28. As shown, LOG A includes the updated transactions 29 and 30 from FIG. 6A. Accordingly, when compute node B reads LOG A, it realizes that two new entries exist: transaction 29 and transaction 30. Compute node B reads these entries and updates its cached meta-data associated with LUN A accordingly. In one embodiment, LOG A includes a transaction number, the meta-data update, and the location in the file system of the update for each entry in the LOG. In other embodiments, each entry in LOG A includes a transaction number and a location in the file system of the update associated with that transaction number. In this case, if there are any updates, compute node B needs to read them from the provided locations in the LUN meta-data.

FIGS. 7A and 7B show an example of the contents of cached file system meta-data, for example, the meta-data updated by compute node B in FIG. 6B. More specifically, FIGS. 7A and 7B illustrates how file system meta-data can be updated by reading an associated log file. In this example, the cached file system meta-data stored in compute node B includes file system A meta-data, file system B meta-data, and file system C meta-data. In this example, file system A metadata is shown exploded both before an update (FIG. 7A) and after an update (FIG. 7B). In one embodiment, tree nodes A, B, C, D, and E of FIG. 7A illustrate meta-data associated with data segments. Likewise, FIG. 7B illustrates that tree node E is modified and that tree node F is added. These modifications could be a result of the transactions associated with transaction IDs 29 and 30, respectively.

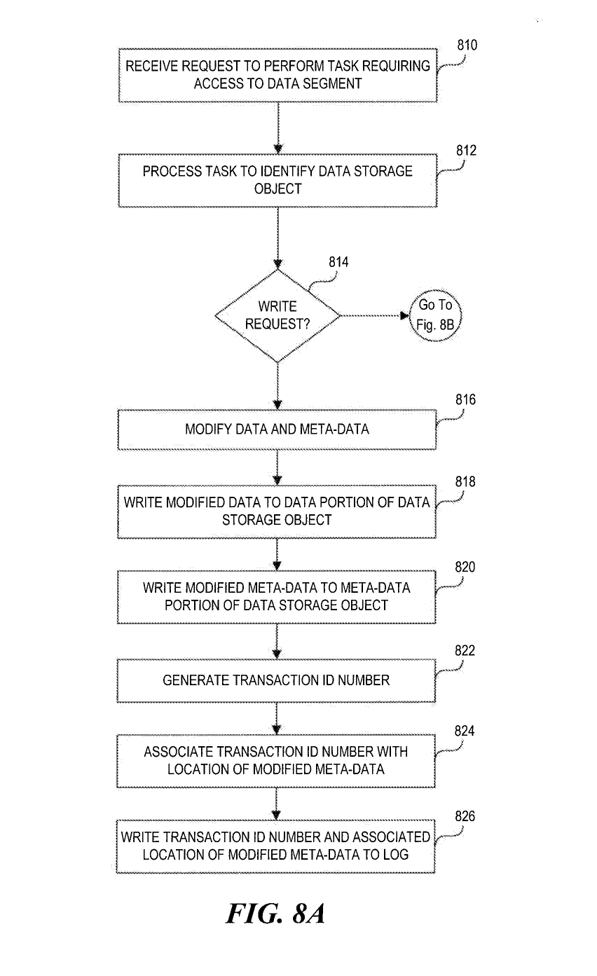

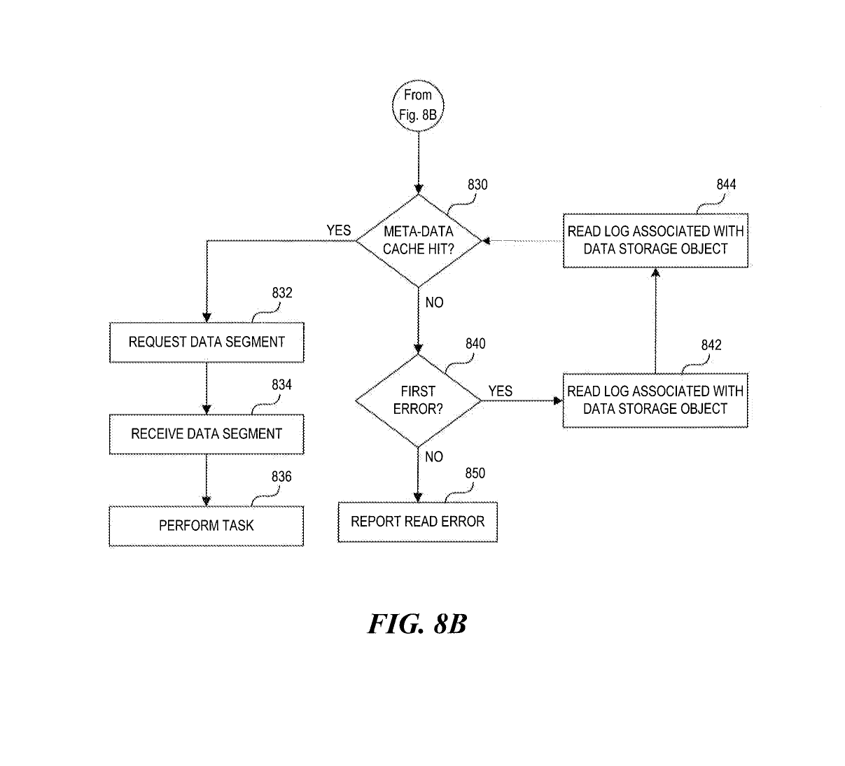

FIGS. 8A and 8B show a flow diagram 800 illustrating an example process for performing a task at a compute node such as, for example, compute node 116 of FIG. 1. In one embodiment, a distributed processing system comprises a plurality of compute nodes. The compute nodes are assembled into compute groups and configured such that each compute group has an attached or local storage system. Various data segments (or chunks) of the distributed data set are stored in data storage objects (e.g., LUNs) on the local storage system. The data storage objects are cross-mapped into each of the compute nodes in the compute group so that any compute node in the group can access any of the data segments (or chunks) stored in the local storage system via the respective data storage object. In this configuration, each compute node owns (i.e., has read-write access) to one data storage object mapped into the compute node and read-only access to the remaining data storage objects mapped into the compute node. Accordingly, the data access is contention-free (i.e., lock-free) because only one compute node can modify the data segments (or chunks) stored in a specified data storage object.

In the receiving stage, at step 810, the compute node receives a request to perform a task requiring access to a data segment of the distributed data set. As discussed above, the distributed data set resides on a plurality of storage systems and each storage system is associated with a compute group having a plurality of compute nodes. Each compute node is cross-mapped into a plurality of data storage objects (e.g., LUNs) in the storage system. In the processing stage, at step 812, the compute node processes the task to identify the data storage on which the data segment is stored. The data storage object is identified from of a plurality of data storage objects mapped into the compute node.

In the access type stage, at step 814, the compute node determines whether the task is a write request. If the task is not a write request, then the compute node does not have to modify the data segment stored in the data storage object. In this case, the process continues at step 830 in FIG. 8B. However, if the task is a write request or includes a write request that modifies the data segment stored in the data storage object then, in the modification stage, at step 816, the compute node modifies the data and the associated meta-data accordingly.

In the data object write stages, at steps 818 and 820, the compute node writes the modified data to the modified to the data portion of the data storage object and the modified meta-data to the meta-data portion of the data storage object. As discussed above, the data and meta-data portions can be separated in the data storage object. In the transaction ID stage, at step 822, the compute node generates a unique transaction ID number. In one embodiment, the transaction ID number can be a rolling number of a specified number of bits. In the association stage, at step 824, the transaction ID is associated with the modifications to the meta-data. The modifications may include a location of the modifications to the meta-data in the file system as well as the meta-data itself.

Lastly, in the log write stage, at step 826, the compute node writes the transaction ID number and the associated location of the modified meta-data to the log. As discussed above, in one embodiment, each data storage object has an associated log. The log can include a plurality of entries where each entry has a transaction ID. The transaction ID is used by other compute nodes (i.e., compute nodes that are non-owners of the data storage object) to determine whether or not the compute node is aware of the transaction. The location of the modified meta-data and the meta-data itself can be included in the log.

Referring next to FIG. 8B, which illustrates the process 800 in the case of a read request. In the meta-data cache stage, at step 830, the compute node determines whether cached file system meta-data associated with the identified data object includes the data segment required to complete the assigned task. If so, in the request stage, at step 832, the compute node requests the data segment from the identified data storage object in the storage system. In the data receive stage, at step 834, the compute node receives the data segment, and in the performance stage, at step 836, the compute node performs the task utilizing the data segment.

However, in some cases, the compute node may not recognize or be able to find the data segment. Such cases are referred to as cache misses. In the case of a cache miss, in the error determination stage, at step 840, the compute node determines whether this error has already occurred. In one embodiment, the compute node determines whether the error has already occurred so that the compute node can identify whether the error is an actual or a merely a perceived error. A perceived error occurs when a data segment is added or modified by another node that owns the data storage object (i.e., has read-write access), but the compute node processing the task is unaware of these changes because they just occurred and the compute node has not periodically read the log associated with the data storage object yet.

According, if the error is the first error, in the log update stage, at step 842, the compute node reads the log associated with the data storage object on which the data segment required to complete the task resides. In the cache update stage, at step 844, the file system cache data associated with the data storage object is updated. As discussed above, in one embodiment, the cached file system data can be updated from the information in the log itself. In other embodiments, the compute node must read the meta-data portion of the data storage object to obtain the updates.

Once the updates are received, in the meta-data cache stage, at step 830, the compute node again determines whether cached file system meta-data associated with the identified data object includes the data segment required to complete the assigned task. If so, the compute node continues to request the data segment, receive the data segment, and perform the task. However, if another cache error occurs then, in the error reporting stage, at step 850, an error is reported to the distribution system (and possibly the client).

The processes described herein are organized as sequences of operations in the flowcharts. However, it should be understood that at least some of the operations associated with these processes potentially can be reordered, supplemented, or substituted for, while still performing the same overall technique.

The techniques introduced above can be implemented by programmable circuitry programmed or configured by software and/or firmware, or they can be implemented entirely by special-purpose “hardwired” circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware for implementing the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, can include, for example, special-purpose hardwired circuitry, software and/or firmware in conjunction with programmable circuitry, or a combination thereof.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
receiving, at a first compute node of a plurality of compute nodes in a distributed processing system, a request to perform a task requiring access to a data segment of a plurality of data segments forming a distributed data set, wherein the data segment is stored in a data storage object on a storage system local to the first compute node;
processing, at the first compute node, the request to identify the data storage object from a plurality of data storage objects mapped into the first compute node; and
requesting, at the first compute node, the data segment from the data storage object on the storage system, wherein the first compute node belongs to a first group of compute nodes of the plurality of compute nodes in the distributed processing system and the first group of compute nodes have contention-free access to the data segment in the data storage object on the storage system.

2. The method of claim 1, wherein the first compute node has read-write access to a primary data storage object and read-only access to the remaining plurality of data storage objects mapped into the first compute node, and wherein the primary data storage object is mapped into other compute nodes of the first group of compute nodes, the other compute nodes having read-only access to the primary data storage object.

3. The method of claim 2, further comprising:
periodically reading, at the first compute node, meta-data transaction logs associated with each of the remaining plurality of data storage objects mapped into the first compute node, the meta-data transaction logs indicating incremental modifications to respective meta-data portions of the remaining data storage objects.

4. The method of claim 2, wherein the remaining plurality of data storage objects mapped into the first compute node each appear to the first compute node as a virtual replica of a data storage object of the remaining plurality of data storage objects.

5. The method of claim 1, further comprising:
comparing, at the first compute node, meta-data associated with the data segment to cached meta-data, wherein the first compute node has read-only access to the data storage object; and
detecting, at the first compute node, a cache miss if the meta-data associated with the data segment cannot be found in the cached meta-data at the first compute node.

6. The method of claim 5, further comprising
in response to the cache miss, reading, at the first compute node, a meta-data transaction log associated with the data storage object; and
updating, at the first compute node, incremental modifications to the cached meta-data portion of the data storage object.

7. The method of claim 1, further comprising:
modifying, at the first compute node, the data segment and meta-data associated with the data segment, wherein the first compute node has read-write access to the data storage object; and
writing, at the first compute node, the modified data set and the modified meta-data associated with the data set to respective data and meta-data portions of the data storage object on the storage system.

8. The method of claim 7, further comprising:
processing, at the first compute node, the modified meta-data associated with the data set to determine incremental modifications to the meta-data portion of the data storage object;
generating, at the first compute node, a transaction identification number;
associating, at the first compute node, the transaction identification number with the incremental modifications to the meta-data portion of the data storage object; and
writing, at the first compute node, the transaction identification number to a meta-data transaction log along with the incremental modifications to the meta-data portion of the data storage object.

9. The method of claim 8, wherein the incremental modifications to the meta-data portion of the data storage object indicate the modified meta-data associated with the data set and a location of the incremental modifications in the meta-data portion of the data storage object on the storage system.

10. The method of claim 9, wherein a second compute node having read-only access to the data storage object periodically reads the meta-data transaction log associated with the data storage object to acquire the incremental modifications to the meta-data portion of the data storage object.

11. The method of claim 1, wherein the data storage object comprises a Logical Unit Number (LUN).

12. The method of claim 1, wherein the task is an independently schedulable element of a compute job.

13. The method of claim 1, wherein the storage system is locally attached to the first compute node.

14. The method of claim 1, wherein the storage system is a totally-ordered system.

15. A compute node of a plurality of compute nodes in a distributed processing system, the compute node comprising:
a network adapter configured to receive a request to perform a task requiring access to a data segment of a plurality of data segments forming a distributed data set stored in a data storage object on an attached storage system;
a storage adapter configured to read the data segment contention-free from the data storage object;
a processing system configured to process the request to perform the task in order to identify the data storage object from a plurality of data storage objects mapped into the compute node, and direct the storage adapter to read the data segment from the data storage object, the processing system having read-write access to a primary data storage object of the plurality of data storage objects and read-only access to a remaining plurality of data storage objects mapped into the compute node; and
a cache system configured to store file system meta-data for each of the plurality of data storage objects mapped into the compute node.

16. The compute node of claim 15, wherein the primary data storage object is mapped into other compute nodes of a plurality of compute nodes in a first group of compute nodes in the distributed processing system, the other compute nodes having read-only access to the primary data storage object.

17. The compute node of claim 15, wherein the processing system is further configured to direct the storage adapter to periodically read meta-data transaction logs for each of the remaining plurality of data storage objects mapped into the compute node, the meta-data transaction logs indicating incremental modifications to meta-data portions of the respective remaining data storage objects.

18. The compute node of claim 15, wherein the processing system is further configured to direct the storage adapter to read the file system meta-data for each of the plurality of data storage objects mapped into the compute node at startup and direct the cache system to store the file system meta-data in the cache system.

19. The compute node of claim 15, wherein the processing system is further configured to direct the storage adapter to read a meta-data transaction log associated with the data storage object, and direct the cache system to update incremental modifications to a meta-data portion of the data storage object responsive to a read error, wherein the compute node has read-only access to the data storage object and the read error indicates that the data segment does not match a cached meta data portion of the data storage object at the compute node.

20. The compute node of claim 19, wherein the processing system is further configured to direct the storage adapter to read the data segment contention-free from the data storage object on the storage system after the update to the incremental modifications of the meta-data portion of the data storage object.

21. The compute node of claim 15, wherein the processing system is further configured to modify the data segment and meta-data associated with the data segment, and direct the storage adapter to write the modified data segment and the modified meta-data associated with the data segment to respective data and meta-data portions of the data storage object on the storage system, wherein the compute node has read-write access to the data storage object.

22. The compute node of claim 21, the processing system further configured to process the meta-data associated with the data segment to determine incremental modifications to the meta-data portion of the data storage object, generate a transaction identification number, direct the storage adapter to write the transaction identification number and the incremental modifications to the meta-data portion of the data storage object to a meta-data transaction log associated with the data storage object.

23. A system of compute nodes in a distributed processing system, the system comprising:
a first compute node configured to receive a first request to perform a first task requiring access to a data segment stored in a data storage object on an attached storage system and process the first request to identify the data storage object from a plurality of data storage objects mapped into the first compute node; and
a second compute node configured to receive a second request to perform a second task requiring access to the data segment stored in the data storage object on the storage system and process the second request to identify the data storage object from the plurality of data storage objects mapped into the second compute node;
wherein the first compute node and the second compute node are configured to access the data segment contention-free from the data storage object on the storage system.

24. The system of compute nodes of claim 23, wherein the first compute node has read-write access to the data storage object and read-only access to a remaining plurality of data storage objects mapped into the first compute node, and wherein the second compute node has read-only access to the data storage object.

25. The system of compute nodes of claim 24, wherein the first compute node is further configured to modify the data segment and meta-data associated with the data segment, and write the modified data segment and the modified meta-data associated with the data segment to respective data and meta-data portions of the data storage object on the storage system.

26. The system of compute nodes of claim 25, wherein the first compute node is further configured to process the meta-data associated with the data segment to determine incremental modifications to the meta-data portion of the data storage object, generate a transaction identification number, associate the transaction identification number with the incremental modifications to the meta-data portion of the data storage object, and write the transaction identification number to a meta-data transaction log along with the incremental modifications to the meta-data portion of the data storage object.

27. The system of compute nodes of claim 26, wherein the second compute node is further configured to periodically read the meta-data transaction log associated with the data storage object to acquire the incremental modifications to the meta-data portion of the data storage object.

28. The system of compute nodes of claim 23, wherein the second compute node is further configured to detect an error in reading the data segment stored in the data storage object indicating that the data segment does not match cached meta data at the second compute node.

29. The system of compute nodes of claim 28, wherein the second compute node is further configured to read a meta-data transaction log associated with the data storage object in response to detecting the error, update incremental modifications to a meta-data portion of the data storage object, and read the data segment contention-free from the data storage object on the storage system.

30. The system of compute nodes of claim 28, further comprising a job distribution system configured to seamlessly handoff the first request to perform the first task requiring access to the data segment stored in the data storage object to the second compute node if the first compute node is unavailable, wherein the data storage object is mapped into the second compute node and the second compute node is configured to receive the first request to perform the first task requiring access to the data segment stored in the data storage object and perform the first task without copying the data storage object.

31. A method comprising:
receiving, at a process distribution system, a request to perform a compute job;
processing, at a process distribution system, the request to divide the compute job into a plurality of independently schedulable tasks, wherein each task requires access to a data segment of a plurality of data segments forming a distributed data set and the data segments are stored in one or more data storage objects on one or more storage systems;
determining, at the process distribution system, whether each task needs to write to the required data segment; and
assigning, at the process distribution system, each task to one of a plurality of compute nodes locally attached to one of the one or more storage systems based on whether the respective task needs to write to the required data segment.

32. The method of claim 31 wherein the process distribution system further assigns each task to one of the plurality of compute nodes based on whether the compute nodes are local to the required data segments.
